(19) United States
(12) Patent Application Publication
(10) Pub. No.: US 2019/0315349 A1
(43) Pub. Date: Oct. 17, 2019

(54) COLLISION DETERMINATION APPARATUS AND METHOD

(71) Applicant: DENSO CORPORATION, Kariya-city (JP)

(72) Inventor: Ryo TAKAKI, Kariya-city (JP)

(21) Appl. No.: 16/383,997

(22) Filed: Apr. 15, 2019

(30) Foreign Application Priority Data
Apr. 17, 2018 (JP) 2018-078910

(51) Int. Cl. B60W 30/09; B60W 30/095

(52) U.S. Cl. CPC B60W 30/09; B60W 2550/306; B60W 30/0956

(57) ABSTRACT

A collision determination apparatus is mounted to an own vehicle. The collision determination apparatus includes an object detection sensor, an estimating unit, a recognizing unit, and an operation changing. The object detection sensor detects an object that is present ahead of the own vehicle. The estimating unit estimates a likelihood of collision between the own vehicle and the object detected by the object detection sensor. The recognizing unit recognizes that the object exhibits a behavior to avoid being rear-ended by the own vehicle. The operation changing unit changes an operation that is performed to avoid colliding with the object, when the likelihood of collision estimated by the estimating unit and the behavior exhibited by the object recognized by the recognizing unit meet a predetermined condition.

### CROSS-REFERENCE TO RELATED APPLICATION

This application is based on and claims the benefit of priority from Japanese Patent Application No. 2018-078910, filed Apr. 17, 2018. The entire disclosure of the above application is incorporated herein by reference.

### BACKGROUND

### Technical Field

The present disclosure relates to a collision determination apparatus.

### Related Art

An apparatus is known in which a warning is issued to a driver of a vehicle when the likelihood of collision with an obstacle ahead of the vehicle reaches a threshold level. The apparatus measures a duration within which the direction of the gaze of the driver of the vehicle is not a frontward direction. The apparatus decreases the threshold level below a reference level as the duration increases. The apparatus thereby advances the timing at which the warning is started.

### SUMMARY

The present disclosure provides a collision determination apparatus that is mounted to an own vehicle. The collision determination apparatus includes an object detection sensor that detects an object that is present ahead of the own vehicle. The collision determination apparatus estimates a likelihood of collision between the own vehicle and the object detected by the object detection sensor. The collision determination apparatus recognizes that the object exhibits a behavior to avoid being rear-ended by the own vehicle. The collision determination apparatus changes an operation that is performed to avoid colliding with the object, when the estimated likelihood of collision and the recognized behavior exhibited by the object meet a predetermined condition.

### BRIEF DESCRIPTION OF THE DRAWINGS

In the accompanying drawings:

FIG. 1 is an explanatory diagram of a configuration of an own vehicle;

FIG. 2 is a block diagram of a collision determination apparatus;

FIG. 3 is an explanatory diagram of a configuration of another vehicle;

FIG. 4 is a flowchart of a collision avoidance operation changing process;

FIG. 5 is a diagram of an operation changing condition; and

FIG. 6 is a table for determining a degree of change in the mode of a collision avoidance operation.

### DESCRIPTION OF THE EMBODIMENTS

In the technology in related art, although the timing of the warning is changed, determination criteria for the likelihood of collision itself is not changed. Thus, even if the warning is issued at an early stage, the warning becomes an erroneous warning if the determination itself regarding the likelihood of collision is erroneous. Therefore, a technology that enables a more accurate determination regarding the likelihood of collision is desired.

An exemplary embodiment of the present disclosure is capable of being implemented according to the following aspects.

The exemplary embodiment provides a collision determination apparatus that is mounted to an own vehicle. The collision determination apparatus includes an object detection sensor, an estimating unit, a recognizing unit, and an operation changing unit. The object detection sensor detects an object that is present ahead of the own vehicle. The estimating unit estimates a likelihood of collision between the own vehicle and the object detected by the object detection sensor. The recognizing unit recognizes that the object exhibits a behavior to avoid being rear-ended (avoid being hit from behind or collided with from behind) by the own vehicle. The operation changing unit changes an operation that is performed to avoid colliding with the object, when the likelihood of collision estimated by the estimating unit and the behavior exhibited by the object recognized by the recognizing unit meet a predetermined condition.

In the collision determination apparatus, not only is the likelihood of collision estimated by the own vehicle, but the behavior exhibited by the object to avoid being rear-ended by the own vehicle (e.g., the likelihood of collision estimated by the object that is the subject of the determination regarding the collision) is recognized. Consequently, the likelihood of collision can be more accurately determined.

The exemplary embodiment can be implemented according to various aspects other than the collision determination apparatus. For example, the exemplary embodiment can be implemented as a method that is performed by the collision determination apparatus, a computer program for implementing the method, a non-transitory computer-readable storage medium in which the computer program is stored, and the like.

### A. First Embodiment

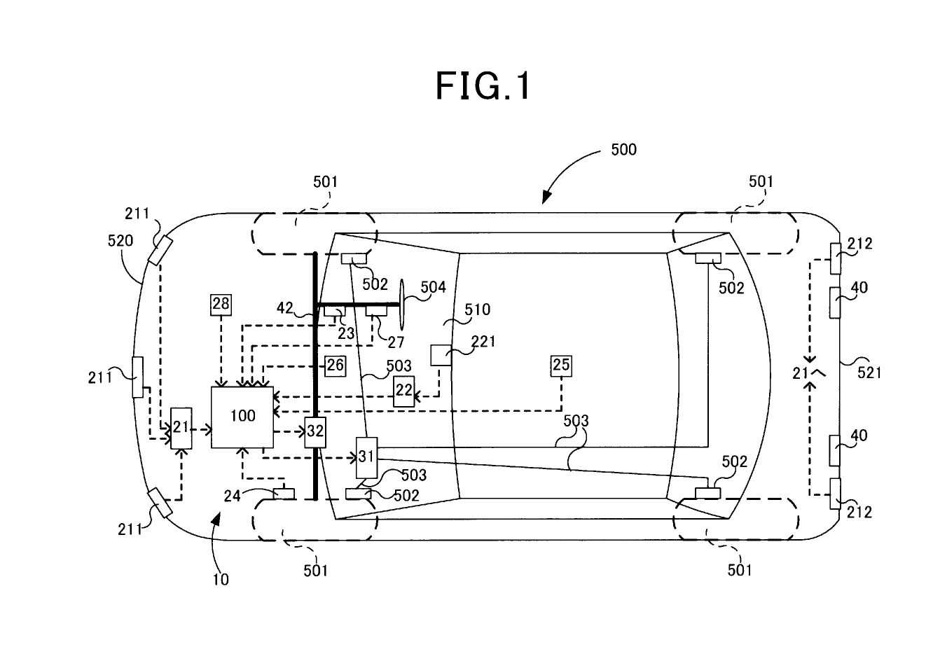

As shown in FIG. 1, a collision determination apparatus 100 according to a first embodiment of the present disclosure that is mounted to a vehicle 500 and serves as a part of a driving assistance system 10. The driving assistance system 10 includes a radar electronic control unit (ECU) 21, a camera ECU 22, a rotation angle sensor 23, a wheel speed sensor 24, a yaw rate sensor 25, a positioning sensor 26, a direction indicator sensor (turn signal sensor) 27, a communication apparatus 28, a braking assistance apparatus 31, and a steering assistance apparatus 32, in addition to the collision determination apparatus 100. The driving assistance system 10 assists in driving of a vehicle by a driver by controlling the various apparatuses described above. The vehicle 500 is also referred to hereafter as an own vehicle 500. A vehicle other than the own vehicle 500 is also referred to as another vehicle.

The radar ECU 21 is connected to a front millimeter-wave radar 211 and a rear millimeter-wave radar 212. The front millimeter-wave radar 211 and the rear millimeter-wave radar 212 each emit radio waves and detect reflected waves that are reflected by a target. The radar ECU 21 generates a detection signal that indicates a target based on a reflection point, using the reflected waves acquired by the millimeter-wave radars 211 and 212. The radar ECU 21 then outputs the detection signal.

The radar ECU may be integrally provided in each of the millimeter-wave radars 211 and 212. In addition to the millimeter-wave radars 211 and 212, a LIDAR (laser radar) or an ultrasonic detector may be used as a detector that detects reflected waves. The ultrasonic detector emits sound waves and detects reflected waves thereof.

The camera ECU 22 is connected to a single-lens front camera 221. The camera ECU 22 generates a detection signal that indicates a target based on an image, using an image acquired by the front camera 221 and a shape pattern of the target that is prepared in advance. The camera ECU 22 then outputs the detection signal. The front camera 221 and the camera ECU 22 may be integrally configured. In addition to the front camera 221, a stereo camera or multiple cameras that are configured by two or more cameras may be used as an imaging apparatus that captures an image of a target. Furthermore, a rear camera or a side camera may also be provided.

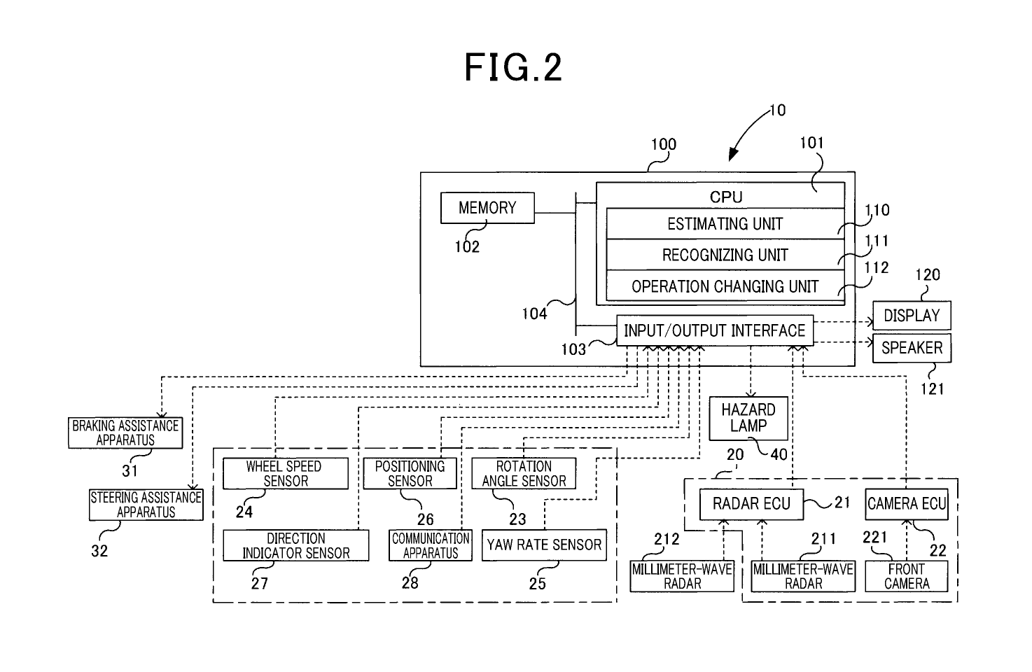

According to the present embodiment, the radar ECU 21 and the millimeter-wave radar 211, and the camera ECU 22 and the front camera 221, described above, are referred to as an “object detection sensor 20” (FIG. 2). The object detection sensor 20 may be configured by only the ECU that corresponds to either of the millimeter-wave radar 211 and the front camera 221. In addition, the object detection sensor 20 may include a LIDAR or an ultrasonic detector.

Each wheel 501 is provided with a braking apparatus 502. For example, each braking apparatus 502 is a disc brake or a drum brake. The braking apparatus 502 brakes the wheel 501 using braking force based on brake fluid pressure of a brake fluid that is supplied via a brake line 503 based on an operation of a brake pedal by the driver. The braking apparatus 502 thereby implements braking of the vehicle 500. The brake line 503 includes a brake piston and a brake fluid line. The brake piston generates the brake fluid pressure based on the operation of the brake pedal. Instead of the brake fluid line, a control signal line may be used as the brake line 504. A configuration in which an actuator that is provided in each braking apparatus 502 is operated may be used.

A steering wheel 504 is connected to the front wheels 501 via a steering apparatus 42. The steering apparatus 42 includes a steering rod, a steering mechanism, and a steering shaft.

As shown in FIG. 2, the collision determination apparatus 100 includes a central processing unit (CPU) 101, a memory 102, an input/output interface 103, and a bus 104. The CPU 101, the memory 102, and the input/output interface 103 are connected to one another by the bus 104. The CPU 101 executes a control program that is stored in the memory 102, and thereby functions as an estimating unit 110, a recognizing unit 111, and an operation changing unit 112.

The estimating unit 110 estimates the likelihood of collision between the own vehicle 500 and an object that is detected by the object detection sensor 20. The recognizing unit 111 recognizes a result of a determination by the object regarding the likelihood of collision between the object and the own vehicle 500. The operation changing unit 112 changes an operation that is performed to avoid colliding with the object, when the likelihood of collision estimated by the estimating unit 110 and the likelihood of collision recognized by the recognizing unit 111 meet a predetermined condition. The contents of processes implemented by these functional units will be described below.

The input/output interface 103 is connected to the radar ECU 21, the camera ECU 22, the rotation angle sensor 23, the wheel speed sensor 24, the yaw rate sensor 25, the positioning sensor 26, the direction indicator sensor 27, the communication apparatus 28, the braking assistance apparatus 31, the steering assistance apparatus 32, a display 120, and a speaker 121. These apparatuses are configured to be capable of transmitting and receiving signals to and from the CPU 101, via the input/output interface 103 and the bus 104. The display 120 and the speaker 121 are provided in the vehicle cabin of the own vehicle 500, and are used to issue a warning to the driver.

The millimeter-wave radars 211 and 212 are sensors that each emit millimeter waves and receive the reflected waves that are reflected by a target. The millimeter-wave radars 211 and 212 thereby detect a distance, a relative speed, and an angle of the target. According to the present embodiment, the front millimeter-wave radar 211 is arranged in the center and both side surfaces of a front bumper 520.

The rear millimeter-wave radar 212 is arranged in both side surfaces of a rear bumper 521. The front millimeter-wave radar 211 detects a target that is present ahead of the own vehicle 500, such as a vehicle that is present ahead, a vehicle that is present diagonally ahead, an oncoming vehicle, or a person who is present ahead. The rear millimeter-wave radar 212 detects a target that is present to the rear of the own vehicle 500, such as a vehicle that is present to the rear or a vehicle that is present diagonally to the rear. The detection signal that is outputted from each of the millimeter-wave radars 211 and 212 is processed by the radar ECU 21 and inputted to the collision determination apparatus 100 as a detection signal that is composed of a point that indicates a position of a target or a sequence of points that indicates a plurality of representative positions of a target.

The front camera 221 is an imaging apparatus that includes a single image sensor, such as a charge-coupled device (CCD). The front camera 221 is a sensor that receives visible light and outputs an outer shape of a target as image data that is a detection result. The camera ECU 22 performs a feature point extraction process on the image data outputted from the front camera 221. The camera ECU 22 compares a pattern that is indicated by the extracted feature points and a target to be determined that is prepared in advance, that is, a comparison pattern that indicates an outer shape of a vehicle. When determined that the extracted pattern and the comparison pattern match or are similar, the camera ECU 22 generates a frame image that includes the determined target.

Meanwhile, when determined that the extracted pattern and the comparison pattern do not match or are not similar, that is, dissimilar, the camera ECU 22 does not generate a frame image. When a plurality of targets are included in the image data, the camera ECU 22 generates a plurality of frame images, each including a determined target. The camera ECU 22 then outputs each frame image as the detection signal. The frame image is represented by pixel data and includes positional information, that is, coordinate information of the determined target.

The camera ECU 22 may detect a target from the image data through image recognition technology using deep learning. According to the present embodiment, the front camera 221 is arranged in an upper center portion of a front windshield 510. The pixel data outputted from the front camera 221 is monochromic pixel data or color pixel data. When a target other than a vehicle, such as a traffic light, a road marking such as a traffic lane and a stop line, or a person is desired as the target to be determined, an outer shape pattern of the desired target may be prepared. The camera ECU 22 may output a frame image that includes the desired target as the detection signal.

The rotation angle sensor 23 is a torque sensor that detects an amount of torsion, that is, steering torque that is generated in the steering rod as a result of the steering wheel 504 being steered. The rotation angle sensor 23 detects a steering angle of the steering wheel 504. According to the present embodiment, the rotation angle sensor 23 is provided in the steering rod that connects the steering wheel 504 and the steering mechanism. A detection signal outputted from the rotation angle sensor 23 is a voltage value that is proportional to the amount of torsion.

The wheel speed sensor 24 is a sensor that detects a rotation speed of the wheel 501. Each wheel 501 is provided with the wheel speed sensor 24. A detection signal outputted from the wheel speed sensor 24 is a voltage value that is proportional to the wheel speed or a pulse signal that indicates an interval based on the wheel speed. The CPU 101 can acquire information, such as the vehicle speed and a traveling distance of the vehicle, using the detection signals from the wheel speed sensors 24.

The yaw rate sensor 25 is a sensor that detects a rotation angular velocity of the vehicle 500. For example, the yaw rate sensor 25 is arranged in a center portion of the vehicle 500. A detection signal outputted from the yaw rate sensor 25 is a voltage value that is proportional to a rotation direction and an angular velocity. A voltage value that indicates a lane change or a left/right turn made by the vehicle 500 can be detected.

For example, the positioning sensor 26 is a sensor that receives a signal from a satellite or a base station, and determines the position of the own vehicle 500. For example, the positioning sensor 26 is a global navigation system satellite (GNSS) receiver or a mobile communication transceiver. The position of the own vehicle 500 is used as current position information of the own vehicle 500.

The direction indicator sensor 27 detects operation of the direction indicator (turn signal) by the driver. That is, the direction indicator sensor 27 detects an operation for a right turn, a left turn, or a lane change. The direction indicator sensor 27 may be provided in the direction indicator.

The communication apparatus 28 transmits and receives information to and from apparatuses outside the vehicle 500 through wireless or optical communication. For example, inter-vehicle communication with another vehicle and road-vehicle communication with a traffic information service provider provided on the road can be performed through the communication apparatus 28. A traveling state, such as the speed or the steering angle, of a vehicle that is present ahead can be acquired through inter-vehicle communication. Various types of information related to the road, such as road restriction information, a road shape, and information on an intersection, can be acquired through road-vehicle communication.

The braking assistance apparatus 31 is an actuator that implements braking by the braking apparatus 502, unrelated to the operation of the brake pedal by the driver. A driver that controls the operation of the actuator based on a control signal from the CPU 101 is mounted in the braking assistance apparatus 31.

According to the present embodiment, the braking assistance apparatus 31 is provided on the brake line 503. The braking assistance apparatus 31 increases and decreases hydraulic pressure in the brake line 503 based on a control signal from the collision determination apparatus 100. As a result, braking assistance and deceleration of the vehicle speed are implemented based on the detection results from the front camera 221 and the millimeter-wave radars 211 and 212.

For example, the braking assistance apparatus 31 is configured by a module that includes an electric motor and a hydraulic piston driven by the electric motor. Alternatively, a brake control actuator that is already used as a side-slip prevention apparatus or an antilock brake system may be used.

The steering assistance apparatus 32 is an actuator that implements steering by the steering apparatus 42, unrelated to the operation of the steering wheel 504 by the driver. A driver that controls the operation of the actuator based on a control signal that designates a steering angle from the CPU 101 is mounted in the steering assistance apparatus 32.

According to the present embodiment, the steering assistance apparatus 32 is provided on the steering shaft. The steering assistance apparatus 32 drives the steering shaft in the left/right direction based on a control signal from the collision determination apparatus 100 and changes the turning angle of the wheels 501 on the front side. As a result, steering assistance based on the detection results from the front camera 211 and the millimeter-wave radars 211 and 212 is implemented.

For example, the steering assistance apparatus 32 is configured by a module that includes an electric motor and a pinion gear driven by the electric motor. The steering shaft is operated by the pinion gear driving a rack gear that is provided on the steering shaft. The steering assistance apparatus 32 may also be used as a steering force assisting apparatus that assists the steering force inputted from the steering wheel 504. In addition, the steering assistance apparatus 32 may also include a configuration in which a motor is arranged on a same axis as the steering shaft. The steering assistance apparatus 32 may be integrally provided with the steering apparatus 42.

Hazard lamps (Hazard lights) 40 are indicator lights that are used to warn other drivers when an emergency stop is to be performed or the like. The hazard lamps 40 are turned on and off by the driver operating a hazard lamp switch (hazard light switch) that is provided inside the vehicle cabin.

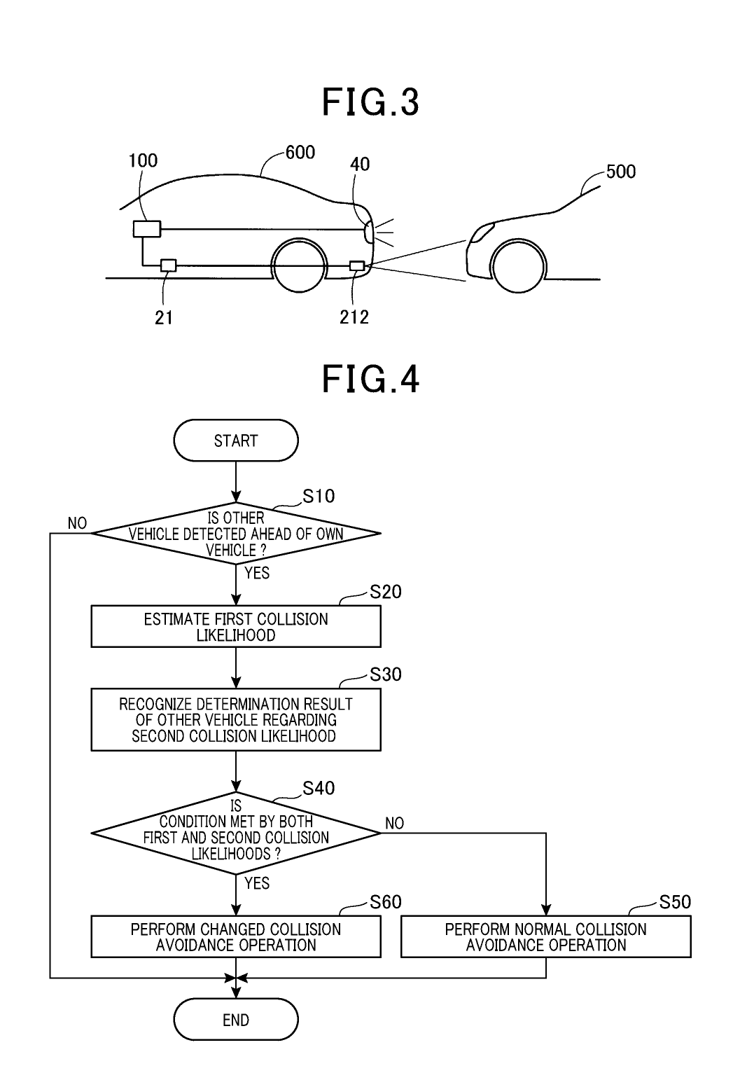

As shown in FIG. 3, the collision determination apparatus 100 provided in an other vehicle 600 detects that a vehicle (own vehicle 500) is approaching from behind using the millimeter-wave radar 212 and the radar ECU 21 provided in the rear of the other vehicle 600. When determined that the likelihood of collision is high, the collision determination apparatus 100 blinks (flashes) the hazard lamps 40 for a number of times that is equal to or greater than a predetermined number of times (three times or more according to the present embodiment) at a collision warning cycle that is a cycle that differs from a normal cycle. The collision determination apparatus 100 thereby issues a warning to the vehicle that follows the other vehicle 600.

That is, the hazard lamps 40 function as a notifying unit (output unit) that notifies the vehicle present to the rear of the result of the determination regarding the likelihood of collision with the vehicle that is approaching from behind. For example, a normal blinking (flashing) cycle of the hazard lamps 40 is 60 times or more and 120 times or less per minute. Therefore, the collision warning cycle is preferably set to be shorter than the normal blinking cycle.

The function for transmitting, to a vehicle that is present to the rear, that a vehicle is approaching from behind is also preferably provided in the own vehicle 500. According to the present embodiment, as described above, the collision warning cycle is a cycle that differs from the normal blinking cycle of the hazard lamps 40. However, the collision warning cycle may be the same cycle as the normal blinking cycle of the hazard lamps 40.

A collision avoidance operation changing process performed by the collision determination apparatus 100 will be described with reference to FIG. 4. The collision avoidance operation changing process is performed to change the mode of an operation that is performed to avoid a collision between the own vehicle 500 and the other vehicle 600, based on the determination result regarding the likelihood of collision from the own vehicle 500 and the determination result of a likelihood of collision from the other vehicle 600. A processing routine shown in FIG. 4 is repeatedly performed at a predetermined control timing, from when a start switch of the own vehicle 500 is turned on until the start switch is turned off

The CPU 101 determines whether an other vehicle 600 is detected ahead of the own vehicle 500 by the object detection sensor 20 (step S10). When determined that an other vehicle 600 is not detected ahead of the own vehicle 500 (NO at step S10), the CPU 101 ends the current collision avoidance operation changing process.

When determined that an other vehicle 600 is detected ahead of the own vehicle 500 (YES at step S10), the estimating unit 110 of the CPU 101 estimates the likelihood of collision (first collision likelihood) between the detected other vehicle 600 and the own vehicle 500 (step S20). The estimating unit 110 determines whether the likelihood of collision is high using the distance to the other vehicle 600 detected by the object detection sensor 20, the position of the other vehicle 600 in the left/right direction, the current vehicle speed of the own vehicle 500, the relative speed of the other vehicle 600, and the like.

For example, the estimating unit 110 determines a time-to-collision (TTC) by dividing the distance to the other vehicle 600 of which the position in the left/right direction partially or entirely overlaps with the own vehicle 500 by the relative speed of the other vehicle 600 from the perspective of the own vehicle 500. When determined that the TTC is less than a predetermined reference value (such as 4 seconds), the estimating unit 110 determines that the likelihood of collision is high.

Next, the recognizing unit 111 of the CPU 101 recognizes the result of the determination performed at the other vehicle 600 side regarding the likelihood of collision (second collision likelihood) between the other vehicle 600 and the own vehicle 500 (step S30).

Here, the determination result of the other vehicle 600 in the present embodiment corresponds to a behavior (e.g., blinking state of hazard lamps 40 provided in the other vehicle 600 shown in FIG. 3) exhibited by the other vehicle 600 to avoid being rear-ended (avoid being hit from behind) by the own vehicle 500 behind the other vehicle 600. Thus, the second collision likelihood can be recognized (estimated) based on the determination result of the other vehicle 600 side, i.e., the behavior exhibited by the other vehicle 600.

According to the present embodiment, the recognizing unit 111 detects the blinking state of the hazard lamps 40 of the other vehicle 600 that is traveling ahead of the own vehicle 500 using the front camera 221 of the object detection sensor 20. When determined that the hazard lamps 40 have blinked for a number of times (such as three times or more) equal to or greater than a predetermined threshold, the recognizing unit 111 recognizes that the other vehicle 600 has determined that the likelihood of collision is high. The threshold (lower limit value) is provided regarding the number of times that the hazard lamps 40 blink to suppress erroneous determination. The recognizing unit 11 may take into consideration a timing at which the hazard lamps 40 of the other vehicle 600 start blinking, when recognizing the determination result regarding the second collision likelihood.

For example, in cases in which the above-described TTC is long (such as 5 seconds or more), when the hazard lamps 40 are already blinking in the other vehicle 600, the recognizing unit 111 recognizes that the other vehicle 600 has not determined that the likelihood of collision is high. In cases in which the TTC is short (such as 4 seconds or less), when the hazard lamps 40 start blinking within this time, the recognizing unit 111 recognizes that the other vehicle 600 has determined that the likelihood of collision is high.

The operation changing unit 112 of the CPU 101 determines whether the likelihood of collision (first collision likelihood) estimated by the own vehicle 500 at step S20 and the likelihood of collision (second collision likelihood) determined by the other vehicle 600 and recognized at step S30 meet an operation changing condition that is a predetermined condition (step S40).

According to the present embodiment, when the determination results are such that both the first collision likelihood and the second collision likelihood indicate that the “likelihood of collision is high,” the operation changing unit 112 determines that the operation changing condition is met. When determined that the operation changing condition is not met (NO at step S40), the operation changing unit 112 performs a normal collision avoidance operation (step S50).

Meanwhile, when determined that the operation changing condition is met (YES at step S40), the operation changing unit 112 performs a collision avoidance operation in which the mode of the operation is changed from the normal collision avoidance operation (step S60). The “collision avoidance operation” according to the present embodiment refers to the driver being warned that the likelihood of collision is high using least either of the display 120 and the speaker 121. When the mode of the collision avoidance operation is to be changed, the operation changing unit 112 sets the timing at which the driver is issued the warning to be earlier than that in the normal collision avoidance operation.

In the collision determination apparatus 100 according to the present embodiment described above, not only is the likelihood of collision estimated by the own vehicle 500, but the likelihood of collision estimated by the other vehicle 600 that is the subject of the determination regarding the collision is recognized. It is then determined whether the mode of the collision avoidance operation performed by the own vehicle 500 is changed. Therefore, the likelihood of collision can be more accurately determined, compared to cases in which the likelihood of collision is estimated by only the own vehicle 500. Consequently, the collision avoidance operation can be performed at an early stage based on a highly reliable determination regarding the likelihood of collision.

According to the present embodiment, as the collision avoidance operation, the driver is warned using at least either of the display 120 and the speaker 121 that are provided in the vehicle cabin. However, the collision avoidance operation is not limited to such a warning. For example, the “collision avoidance operation” may be braking assistance performed by the braking assistance apparatus 31. In this case, when the mode of the collision avoidance operation is to be changed, the operation changing unit 112 sets the timing at which braking assistance is performed to be earlier than that for normal braking assistance.

In addition, the “collision avoidance operation” may be steering assistance performed by the steering assistance apparatus 32. In this case, when the mode of the collision avoidance operation is to be changed, the operation changing unit 112 sets the timing at which steering assistance is performed to be earlier than that in the normal collision avoidance operation.

Furthermore, the “collision avoidance operation” may be tightening of seatbelts. In this case, when the mode of the collision avoidance operation is to be changed, the operation changing unit 112 sets the timing at which the seatbelts are tightened to be earlier than that in the normal collision avoidance operation. The collision avoidance operation is not limited to only one of the warning, the braking assistance, the steering assistance, and the tightening of the seatbelts, and may also be a combination of two or more thereof.

Moreover, when the mode of the collision avoidance operation is to be changed, the operation changing unit 112 may change the degree by which the warning, the braking assistance, the steering assistance, or the tightening of the seatbelts is performed, that is, the intensity of color in the display 120, the sound volume of the warning, the force of braking, the amount of movement of the vehicle 50 resulting from steering assistance, or the force of tightening of the seatbelts, instead of, or in addition to, setting the timing of the warning, the braking assistance, the steering assistance, or the tightening of the seatbelts to be earlier.

In addition, the collision avoidance operation itself may be changed from the normal operation. For example, whereas a warning issued through the display 120 is normally performed, a warning issued through sound may be performed when the mode of the collision avoidance operation is changed. That is, the “mode of the collision avoidance operation is changed” includes a change in the timing of the collision avoidance operation, a change in the degree of the collision avoidance operation, and a change in the collision avoidance operation itself.

### B. Second Embodiment

According to the first embodiment described above, the mode of the collision avoidance operation is changed when the likelihood of collision is determined to be high in both the own vehicle 500 and the other vehicle 600. In contrast, according to a second embodiment, the mode of the collision avoidance operation is changed based on a level of the first collision likelihood estimated by the own vehicle 500 and a level of the second collision likelihood estimated by the other vehicle 600.

The estimating unit 110 can identify the level of the first collision likelihood based on the distance to the other vehicle and the current vehicle speed. In addition, the collision determination apparatus 100 mounted to the other vehicle 600 identifies the level of the second collision likelihood based on the distance to the vehicle that is present to the rear and the relative speed of the vehicle that is present to the rear. The collision determination apparatus 100 mounted to the other vehicle 600 then changes the blinking cycle of the hazard lamps 40 based on the identified level. Therefore, the recognizing unit 111 of the own vehicle 500 can recognize the level of the second collision likelihood by detecting the blinking cycle of the hazard lamps 40.

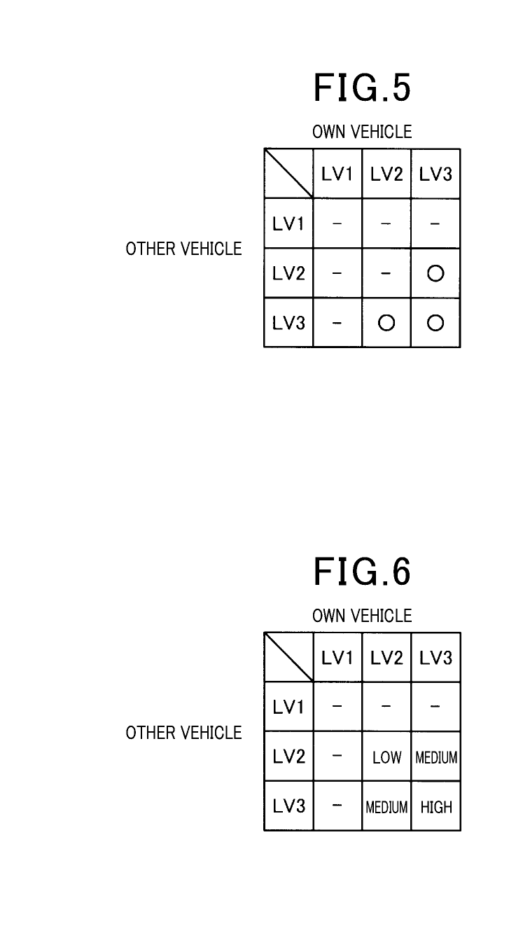

At S40 in the flowchart shown in FIG. 4, the operation changing unit 112 according to the present embodiment determines whether to change the mode of the collision avoidance operation based on an operation changing condition shown in FIG. 5.

According to the present embodiment, as shown in FIG. 5, levels from level 1 to level 3 are prescribed for each of the first collision likelihood estimated by the own vehicle 500 and the second collision likelihood estimated by the other vehicle 600. The likelihood of collision increases as the numeric value of the level increases.

According to the present embodiment, the operation changing unit 112 determines that the operation changing condition is met when a condition indicated by circles (∘) is met. That is, the operation changing unit 112 determines that the operation changing condition is met when the first collision likelihood and the second collision likelihood are both level 2 or higher, and at least either of the first collision likelihood and the second collision likelihood is level 3.

According to the second embodiment described above, it is determined whether the mode of the collision avoidance operation is changed, based on the level of the first collision likelihood estimated by the own vehicle 500 and the level of the second collision likelihood estimated by the other vehicle 600. Consequently, the determination regarding the likelihood of collision can be more accurately performed.

### C. Third Embodiment

According to the second embodiment described above, it is determined whether the mode of the collision avoidance operation is changed, based on the level of the first collision likelihood estimated by the own vehicle 500 and the level of the second collision likelihood estimated by the other vehicle 600. In contrast, according to a third embodiment, a degree of change in the mode of the collision avoidance operation is determined based on the level of the first collision likelihood estimated by the own vehicle 500 and the level of the second collision likelihood estimated by the other vehicle 600.

According to the present embodiment, in a manner similar to that according to the first embodiment or the second embodiment, at step S40 in the flowchart shown in FIG. 4, the operation changing unit 112 determines whether the first collision likelihood and the second collision likelihood meet the operation changing condition. Then, when determined that the operation changing condition is met (YES at step S40), the operation changing unit 112 determines the degree of change in the mode of the collision avoidance operation based on the level of the first collision likelihood estimated by the own vehicle 500 and the level of the second collision likelihood estimated by the other vehicle 600.

According to the present embodiment, as shown in FIG. 6, in a manner similar to that according to the second embodiment, levels from level 1 to level 3 are prescribed for each of the first collision likelihood estimated by the own vehicle 500 and the second collision likelihood estimated by the other vehicle 600. The likelihood of collision increases as the numeric value of the level increases.

The operation changing unit 112 according to the present embodiment determines the degree of change in the mode of the of the collision avoidance operation based on the degrees indicated by “low,” “medium,” and “high” in FIG. 6. Therefore, for example, when the collision avoidance operation is a warning to the driver, the operation changing unit 112 sets the timing of the warning to be earlier as the degree prescribed in FIG. 6 becomes higher.

According to the third embodiment described above, the degree of change in the mode of the collision avoidance operation is determined based on the level of the first collision likelihood estimated by the own vehicle 500 and the level of the second collision likelihood estimated by the other vehicle 600. Consequently, the own vehicle 50 can be made to perform a more appropriate collision avoidance operation.

### D. Other Embodiments

(D-1) According to the above-described embodiments, the hazard lamps 40 are applied as the notifying unit. The recognizing unit 111 recognizes the second collision likelihood determined in the other vehicle 600 based on the blinking state of the hazard lamps 40. However, the second collision likelihood may be transmitted by an apparatus other than the hazard lamps 40. For example, the communication apparatus 28 may be applied as the notifying unit. The second collision likelihood determined by the collision determination apparatus 100 provided in the other vehicle 600 may be transmitted to the own vehicle 500 through inter-vehicle communication using the communication apparatus 28.

In addition, for example, a speaker that is capable of generating sound towards the vehicle that is present to the rear may be provided in the other vehicle 600. The second collision likelihood may be transmitted to the vehicle 500 that is present to the rear through sound using the speaker. Furthermore, for example, a display that faces the rear may be provided in the other vehicle 600. The second collision likelihood may be transmitted to the vehicle 500 that is present to the rear by information indicating the second collision likelihood being displayed on the display.

(D-2) According to the above-described embodiments, the collision determination apparatus 100 detects the other vehicle 600 that is present ahead using the object detection sensor 20. In this regard, the collision determination apparatus 100 may detect the other vehicle 600 that is present ahead using inter-vehicle communication or road-vehicle communication.

(D-3) According to the above-described embodiments, the recognizing unit 111 recognizes that the likelihood of collision is determined to be high in the other vehicle 600 that is traveling ahead when the hazard lamps 40 of the other vehicle 600 blinks for a number of times equal to or greater than the predetermined threshold. In this regard, the threshold for the number of times that the hazard lamps 40 blink may be varied based on the level of the likelihood of collision estimated by the estimating unit 110.

For example, when the level of the first collision likelihood estimated by the estimating unit 110 is high, the threshold for the number of times that the hazard lamps 40 blink is two times. When the level of the first collision likelihood estimated by the estimating unit 110 is low, the threshold for the number of times that the hazard lamps 40 blink is five times.

In this manner, the likelihood of an erroneous determination decreases as the level of the first collision likelihood determined by the own vehicle 500 increases. Therefore, the threshold for the number of times that the hazard lamps 40 blink can be decreased. As a result, the timing at which the second collision likelihood is recognized can be made earlier. Consequently, the collision avoidance operation can be performed at a more appropriate timing.

(D-4) According to the above-described embodiments, the recognizing unit 111 recognizes the likelihood of collision determined by the other vehicle 600 that is present ahead. In this regard, the recognizing unit 111 may recognize the likelihood of collision determined by an object other than a vehicle, such as a person.

Specifically, the recognizing unit 111 can recognize that a person who is present ahead has determined that the likelihood of collision is high when the front camera 221 detects that the person is waving their hand at the own vehicle 500, is making a gesture to “stop” by thrusting their hand outward, appears surprised, has suddenly become still, has crouched down, or the like. For example, a relationship between such actions by a person and the likelihood of collision is preferably learned by a method such as deep learning to increase precision.

(D-5) According to the above-described embodiments, the collision determination apparatus 100 provided in the other vehicle 600 detects that a vehicle is approaching from behind, using the millimeter-wave radar 212 that is provided in the rear and the radar ECU 21. In this regard, the driver or a passenger of the other vehicle 600 who has noticed the approach of a vehicle from behind may press a predetermined operating button and blink the hazard lamps 40. The recognizing unit 111 of the own vehicle 500 can recognize that the likelihood of collision has been determined in the other vehicle 600 that is present ahead, in this manner as well.

(D-6) According to the above-described embodiments, the front camera 221 detects the blinking of the hazard lamps 40 of the other vehicle 600 that is present ahead. In this regard, the collision determination apparatus 100 of the other vehicle 600 may transmit a notification that the hazard lamps 40 are blinking to the vehicle that is present to the rear by inter-vehicle communication.

(D-7) According to the above-described embodiments, the own vehicle 500 and the other vehicle 600 are not limited to four-wheeled vehicles, such as passenger cars and trucks, and may be motorcycles, motorized tricycles, specialized vehicles such as construction vehicles, and the like.

(D-8) According to the above-described embodiments, the collision determination apparatus 100 preferably does not recognize the blinking of the hazard lamps 40 of an other vehicle 600 that is stopped, that is, an other vehicle 600 of which the vehicle speed is zero. As a result, the mode of the collision avoidance operation of the own vehicle 500 being changed as a result of the other vehicle 600 that is stopped can be suppressed.

The present disclosure is not limited to the above-described embodiments and can be implemented by various configurations without departing from the spirit of the disclosure. For example, technical features according to the embodiments can be replaced or combined as appropriate to solve some or all of the above-described issues or achieve some or all of the above-described effects. The technical features may be omitted as appropriate unless described as a requisite in the present specification.

What is claimed is:

1. A collision determination apparatus that is mounted to an own vehicle, the collision determination apparatus comprising:
an object detection sensor that detects an object that is present ahead of the own vehicle;
an estimating unit that estimates a likelihood of collision between the own vehicle and the object detected by the object detection sensor;
a recognizing unit that recognizes that the object exhibits a behavior to avoid being rear-ended by the own vehicle; and
an operation changing unit that changes an operation that is performed to avoid colliding with the object, when the likelihood of collision estimated by the estimating unit and the behavior exhibited by the object recognized by the recognizing unit meet a predetermined condition.

2. The collision determination apparatus according to claim 1, wherein:
the operation changing unit changes the mode of the operation, when a first collision likelihood and a second collision likelihood meet a predetermined condition, where:
the first collision likelihood is the likelihood of collision estimated by the estimating unit; and
the second collision likelihood is determined based on the behavior exhibited by the object recognized by the recognizing unit.

3. The collision determination apparatus according to claim 2, wherein:
the object is an other vehicle that estimates a likelihood of collision with a vehicle that is approaching the other vehicle from behind, the object including a notifying unit (40) that notifies a vehicle behind the other vehicle of the likelihood of collision estimated by the other vehicle; and
the recognizing unit recognizes the second collision likelihood based on the estimated likelihood of collision notified to the own vehicle by the notifying unit of the other vehicle.

4. The collision determination apparatus according to claim 2, wherein:
the condition is prescribed based on a level of the first collision likelihood estimated by the estimating unit and a level of the second collision likelihood recognized by the recognizing unit.

5. The collision determination apparatus according to claim 3, wherein:
the condition is prescribed based on a level of the first collision likelihood estimated by the estimating unit and a level of the second collision likelihood recognized by the recognizing unit.

6. The collision determination apparatus according to claim 2, wherein:
the operation changing unit determines a degree of change in the mode of the operation based on a level of the first collision likelihood estimated by the estimating unit and a level of the second likelihood recognized by the recognizing unit.

7. The collision determination apparatus according to claim 3, wherein:
the operation changing unit determines a degree of change in the mode of the operation based on a level of the first collision likelihood estimated by the estimating unit and a level of the second likelihood recognized by the recognizing unit.

8. The collision determination apparatus according to claim 4, wherein:
the operation changing unit determines a degree of change in the mode of the operation based on a level of the first collision likelihood estimated by the estimating unit and a level of the second likelihood recognized by the recognizing unit.

9. The collision determination apparatus according to claim 5, wherein:
the operation changing unit determines a degree of change in the mode of the operation based on a level of the first collision likelihood estimated by the estimating unit and a level of the second likelihood recognized by the recognizing unit.

10. The collision determination apparatus according to claim 1, wherein:
the recognizing unit recognizes, as the behavior exhibited by the object, a blinking state of hazard lamps provided in an other vehicle ahead of the own vehicle.

11. The collision determination apparatus according to claim 1, wherein:
the estimating unit estimates the first collision likelihood based on a time-to-collision that is determined by: a relative speed between the own vehicle and an other vehicle ahead of the own vehicle; and a distance between the own vehicle and the other vehicle.

12. A system that is mounted to an own vehicle including an object detection sensor that detects an object that is present ahead of the own vehicle, the system comprising:
a processor;
a non-transitory computer-readable storage medium; and
a set of computer-readable instructions stored in the computer-readable storage medium that when read and executed by the processor, cause the processor to implement:
estimating a likelihood of collision between the own vehicle and the object detected by the object detection sensor;
recognizing that the object exhibits a behavior to avoid being rear-ended by the own vehicle; and
changing an operation that is performed to avoid colliding with the object, when the estimated likelihood of collision and the recognized behavior exhibited by the object meet a predetermined condition.

13. A method performed by an own vehicle, the method comprising:
detecting an object that is present ahead of the own vehicle using an object detection sensor;
estimating a likelihood of collision between the own vehicle and the object detected by the object detection sensor;
recognizing that the object exhibits a behavior to avoid being rear-ended by the own vehicle; and
changing an operation that is performed to avoid colliding with the object, when the likelihood of collision estimated by the estimating unit and the behavior exhibited by the object recognized by the recognizing unit meet a predetermined condition.
